(19) United States
(12) Patent Application Publication
(10) Pub. No.: US 2019/0148782 A1
(43) Pub. Date: May 16, 2019

(54) BATTERY DEVICE HAVING ANTI-FIRE SPREADING STRUCTURE

(71) Applicant: STL Technology Co.,Ltd., Kaohsiung City (TW)

(72) Inventor: Chen-Yen Chang, Kaohsiung City (TW)

(21) Appl. No.: 16/052,863

(22) Filed: Aug. 2, 2018

(30) Foreign Application Priority Data
Nov. 16, 2017 (CN) 201711138278.5

(51) Int. Cl. H01M 10/42; H01M 2/10; A62C 2/06

(52) U.S. Cl. CPC H01M 10/4207; H01M 2200/00; A62C 2/06; H01M 2/1077

(57) ABSTRACT

The invention provides a battery device having anti-fire spreading structure, which comprises a plurality of battery cells and a multi-layer housing frame. The battery cells are connected in series or in parallel, and arranged in each layer of housing frame. Each of battery cells is placed in a anti-fire casing tube, respectively. Each of battery cells in each layer of housing frame is isolated from each other by an anti-fire passage. A conductive metal surface is disposed on the housing frame. An electrode terminal of each battery cell is connected to the conductive metal surface via a fuse of upward bending, respectively. Accordingly, by the dispositions of one or more anti-fire spreading structures, which will reduce the probability of spread burning of the battery cells so as to increase the safety of the battery device in using.

This non-provisional application claims priority claim under 35 U.S.C. § 119 (a) on China Patent Application No. 201711138278.5 filed Nov. 16, 2017, the entire contents of which are incorporated herein by reference.

### FIELD OF THE INVENTION

The present invention relates to a battery device, particularly to a battery device having anti-fire spreading structure.

### BACKGROUND

The battery cell is used for storing electrical energy. A plurality of battery cells are connected in series or in parallel to form a battery device, which can be used as a power source for a machine, for example, the battery device is as the power source for the electric vehicle.

Since the output energy of the battery device is a momentary high current, the battery cells are easy to generate high temperature, such that the service life of the battery cell is greatly shortened. Besides, when the battery cell is impacted by an external force, it may also cause an ejection of high-heat flame that will be spread to other battery cells, resulting in the explosion of the battery device.

In order to prevent that the burning of the battery cell is spreaded, the inner frame and the outer housing of the convention battery device are often made of a material with a higher hardness or a filling gel, so that the strength of packaging of the battery device can be increased to reduce the probability of the spread burning of the battery cells. However, the higher hardness material or the filling gel will increase the manufacturing cost and weight of the battery device, it is very unfavorable for the product price and the using of the battery device.

For the above reason, the present invention provides an innovative battery device, the inner of which is provided with one or more anti-fire spreading structures, in such a way that can not only reduce the probability of the spread burning of the battery cell, but also increase the safety of the use of the battery device, as well as without increasing the production cost, so that the product price of the battery device can be relatively low, it will be the objective of this invention.

### SUMMARY

It is one objective of the present invention to provide a battery device, which comprises a multi-layer housing frame and a plurality of battery cells. Each of battery cells is connected together in serial or parallel, and arranged in each layer of the housing frame, respectively. The housing frame is provided with at least one anti-fire passage therein. The battery cells in each layer of the housing frame can be isolated from each other by the anti-fire passage. When one of battery cells damages and therefore burns, the smoke, the heat or the flame formed by the damaged battery cell can be isolated by the anti-fire passage, avoided to conduct to the front and rear battery cells, and guided to the outside of the housing frame so as to decrease the probability of spread burning.

It is another objective of the present invention to provide a battery device, in which each of battery cells is placed in a anti-fire casing tube and covered by the anti-fire casing tube, each of battery cells is isolated from the adjacent battery cell by the anti-fire casing tube. When the battery cell damages and therefore burns, the smoke, the heat, or the flame formed by the damaged battery cell can be isolated and heat dissipated by the anti-fire casing tube, and avoided to conduct to the adjacent battery cell to prevent the probability of spread burning.

It is another objective of the present invention to provide a battery device, which comprises a conductive metal surface and a plurality of fuses, the connection between the conductive metal surface, the fuse, and an electrode terminal of the battery cell is designed in the form of a gap; when the fuse is blown, even if the short-circuit battery cell occurs the shaking of the left and right displacement, the electrode terminal of the short-circuit battery cell also will not contact with the incompletely blown fuse, so as to avoid that the current path between the short-circuit battery cell and the conductive metal surface is re-conducted.

To achieve the above objective, the present invention provides a battery device having anti-fire spreading structure, comprising: a plurality of battery cells; a multi-layer housing frame, wherein each of battery cells is connected together in serial or parallel, and arranged in each layer of the housing frame, respectively; and at least one anti-fire passage, separated by a plurality of insulation sheets, and arranged in each layer of the housing frame, respectively, wherein the battery cells in each layer of the housing frame can be isolated from each other by the anti-fire passage.

In one embodiment of the present invention, each of the battery cells is placed in a anti-fire casing tube, respectively.

In one embodiment of the present invention, the battery device further comprises a conductive metal surface and a plurality of fuses, the conductive metal surface is disposed on the housing frame, each of the fuses is connected at an end thereof to the conductive metal surface, and connected at other end thereof to an electrode terminal of the corresponding battery cell.

In one embodiment of the present invention, a height difference is existed between a plane of the conductive metal surface and a plane of the electrode terminal of each of the battery cells, the electrode terminal of each of the battery cells is connected to the conductive metal surface via the fuse of upward bending.

The present invention further provides a battery device having anti-fire spreading structure, comprising: a plurality of battery cells; and a multi-layer housing frame, wherein each of battery cells is connected together in serial or parallel, and arranged in each layer of the housing frame, respectively; wherein each of the battery cells is placed in a anti-fire casing tube, respectively.

### BRIEF DESCRIPTION OF THE DRAWINGS

FIG. 1 is shown a three-dimensional view of the battery device according to one embodiment of the present invention.

FIG. 2 is shown a cross-sectional view of the battery device according to one embodiment of the present invention.

FIG. 2A is an enlarged view of part of structure of FIG. 2 of the present invention.

FIG. 3 is shown a cross-sectional view of the battery cells of the battery device according to one embodiment of the present invention.

FIG. 4A is shown a three-dimensional view of parts of the conductive metal surface of the battery device of the present invention.

FIG. 4B is shown a side view of the electrical connection between the conductive metal surface, the fuse, and the electrode terminal of the present invention.

### DETAILED DESCRIPTION OF THE PREFERRED EMBODIMENTS

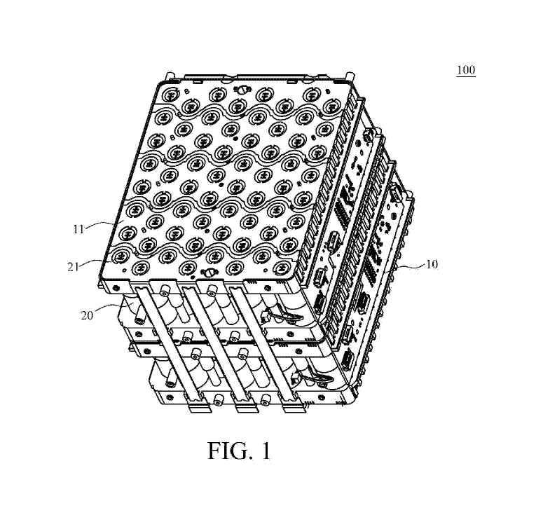

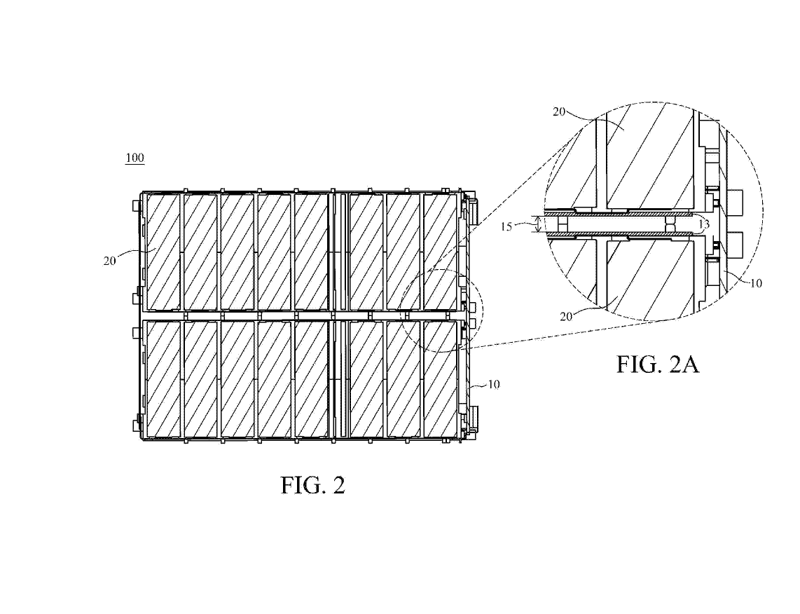

Referring to FIG. 1 and FIG. 2, there are shown a three-dimensional view and a cross-sectional view of the battery device according to one embodiment of the present invention, respectively. As shown in FIG. 1 and FIG. 2, the battery device 100 comprises a multi-layer housing frame 10 and a plurality of battery cells 20. Each of battery cells 20 is connected together in serial or parallel, and arranged in each layer of the housing frame 10, respectively.

As shown in FIG. 2A, the housing frame 10 of each layer is provided with at least one anti-fire passage 15. The anti-fire passage 15 is separated by a plurality of insulation sheets 13. In one embodiment of the present invention, the insulation sheet 13 is a thin sheet made of a anti-fire material. The anti-fire passage 15 is disposed between an electrode terminal of one battery cell 20 and an electrode terminal of other adjacent battery cell 20. Each battery cell 20 is isolated from the battery cell 20 of the upper layer or the battery cell 20 of the lower layer by the anti-fire passage 15. When one of battery cells 20 damages and therefore burns because it is punctured or impacted, the smoke, the heat or the flame formed by the damaged battery cell 20 can be isolated by the anti-fire passage 15, avoided to conduct to the front and rear battery cells 20, and guided to the outside of the housing frame 10 so as to decrease the probability of spread burning of the battery cells 20.

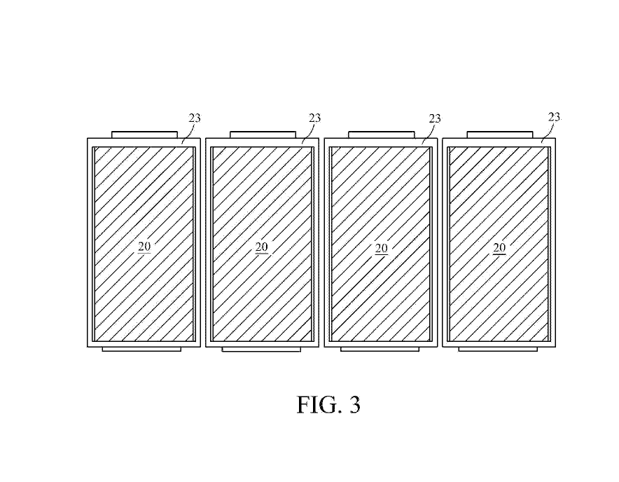

Referring to FIG. 3, there is shown a cross-sectional view of the battery cells of the battery device according to one embodiment of the present invention. As shown in FIG. 3, each of battery cells 20 of the present invention is placed in an anti-fire casing tube 23 and covered by the anti-fire casing tube 23, respectively. In one embodiment of the present invention, the anti-fire casing tube 23 is a thin tube made of an anti-fire material. Each of battery cells 20 is isolated from the adjacent battery cell 20 by the anti-fire casing tube 23. When the battery cell 20 damages and therefore burns, the smoke, the heat, or the flame formed by the damaged battery cell 20 can be isolated and heat dissipated by the anti-fire casing tube 23, and avoided to conduct to the adjacent battery cell 20 so as to prevent the probability of spread burning.

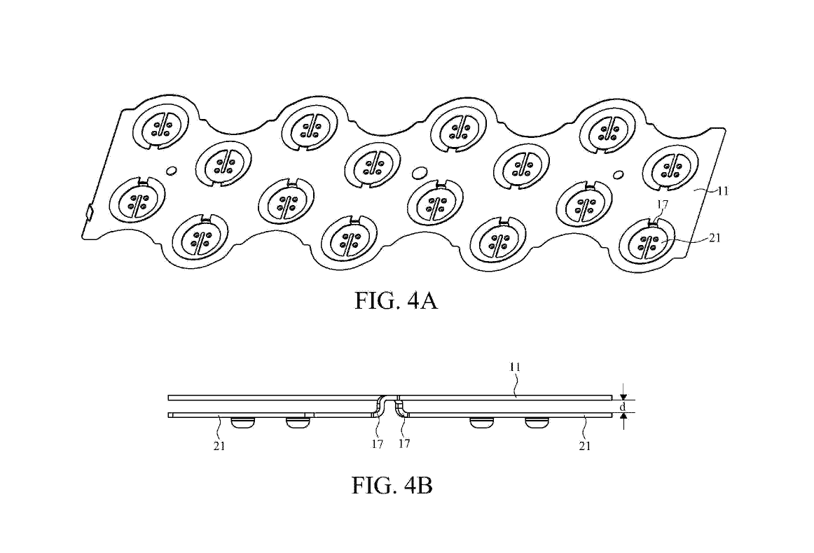

Referring to FIG. 4A and FIG. 4B, there are shown a three-dimensional view of parts of the conductive metal surface of the battery device, and a side view of the electrical connection between the conductive metal surface, the fuse, and the electrode terminal of the present invention, as well as simultaneously referring to FIG. 1. As shown in these Figures, the housing frame 10 of the battery device 100 is provided with a conductive metal surface 11 thereon. Each of battery cells 20 is connected to the housing frame 10 via a fuse 17, respectively, for example, the fuse 17 is connected at an end thereof to the conductive metal surface 11, and connected at other end thereof to an electrode terminal 21 (such as positive terminal or negative terminal) of the corresponding battery cell 20. Each of battery cells 20 is connected together via the conductive metal surface 11.

In the present invention, each of battery cells 20 has its own fuse 17, respectively. If any battery cell 20 generates an abnormal current due to a short-circuit, the fuse 17 electrically connected to the short-circuit battery cell 20 will be blown by the high temperature so that an open circuit is generated between the electrode terminal 21 of the short-circuit battery cell 20 and the conductive metal surface 11 to avoid that the other battery cells 20 in normal operation are affected.

Sequentially, the short-circuit battery cell 20 will generate a left-right displacement in the housing frame 10 after the fuse 17 is blown. If the connection between the conductive metal surface 11, the fuse 17 and the electrode terminal 21 of the battery cell 20 is designed in a way of planar, the short-circuit battery cell 20 will be re-connected to the incompletely blown fuse 17 due to the left and right displacement, such that the current path between the short-circuit battery cell 20 and the conductive metal surface 11 will be re-conducted, which will cause the risk of other normal battery cells 20 to be damaged.

In order to avoid the short-circuit battery cell 20 to be re-connected to the incompletely blown fuse 17, the connection between the conductive metal surface 11, the fuse 17, and the electrode terminal 21 of the battery cell 20 is designed in the form of a gap, such that a height difference (d) is existed between a plane of the conductive metal surface 11 and a plane of the electrode terminal 21 of each of battery cells 20, for example, the plane of the conductive metal surface 11 is higher than the plane of the electrode terminal 21 of each of battery cells 20. The electrode terminal 21 of the battery cell 20 is connected to the conductive metal surface 11 via the fuse 17 of upward bending. When the fuse 17 is blown, the blown location will occur at a turning point between the fuse 17 and the battery cell 20. Thus, even if the short-circuit battery cell 20 occurs the shaking of the left and right displacement, the electrode terminal 21 of the battery cell 20 also will not contact with the incompletely blown fuse 17, so as to avoid that the current path between the short-circuit battery cell 20 and the conductive metal surface 11 is re-conducted.

Summing up, when the damaged battery cell 20 generates to burn, the smoke, the heat or the flame formed by the damaged battery cell 20 will be isolated by the anti-fire passage 15 and the anti-fire casing tube 23, and not be conducted to the surrounding normal battery cell 20, so as to avoid the chance of spread burning or delay the flash fire time. Besides, the connection between the conductive metal surface 11, the fuse 17, and the electrode terminal 21 of the battery cell 20 is implemented in the form of the gap; thus, even if the short-circuit battery cell 20 occurs the shaking of the left and right displacement, the electrode terminal 21 of the battery cell 20 also will not contact with the incompletely blown fuse 17, so as to avoid that the current path between the short-circuit battery cell 20 and the conductive metal surface 11 is re-conducted, and therefore the safety of the battery device in using can be increased.

The above disclosure is only the preferred embodiment of the present invention, and not used for limiting the scope of the present invention. All equivalent variations and modifications on the basis of shapes, structures, features and spirits described in the claims of the present invention should be included in the claims of the present invention.

1. A battery device having anti-fire spreading structure, comprising:
a plurality of battery cells;
a multi-layer housing frame, wherein each of battery cells is connected together in serial or parallel, and arranged in each layer of the housing frame, respectively; and
at least one anti-fire passage, separated by a plurality of insulation sheets, and arranged in each layer of the housing frame, respectively, wherein the battery cells in each layer of the housing frame can be isolated from each other by the anti-fire passage.

2. The battery device having anti-fire spreading structure according to claim 1, wherein each of the battery cells is placed in a anti-fire casing tube, respectively.

3. The battery device having anti-fire spreading structure according to claim 1, wherein the battery device further comprises a conductive metal surface and a plurality of fuses, the conductive metal surface is disposed on the housing frame, each of the fuses is connected at an end thereof to the conductive metal surface, and connected at other end thereof to an electrode terminal of the corresponding battery cell.

4. The battery device having anti-fire spreading structure according to claim 3, wherein a height difference is existed between a plane of the conductive metal surface and a plane of the electrode terminal of each of the battery cells, the electrode terminal of each of the battery cells is connected to the conductive metal surface via the fuse of upward bending.

5. A battery device having anti-fire spreading structure, comprising:
a plurality of battery cells; and
a multi-layer housing frame, wherein each of battery cells is connected together in serial or parallel, and arranged in each layer of the housing frame, respectively;
wherein each of the battery cells is placed in a anti-fire casing tube, respectively.

6. The battery device having anti-fire spreading structure according to claim 5, wherein the battery device further comprises at least one anti-fire passage, the anti-fire passage is separated by a plurality of insulation sheets, the battery cells in each layer of the housing frame can be isolated from each other by the anti-fire passage.

7. The battery device having anti-fire spreading structure according to claim 5, wherein the battery device further comprises a conductive metal surface and a plurality of fuses, the conductive metal surface is disposed on the housing frame, each of the fuses is connected at an end thereof to the conductive metal surface, and connected at other end thereof to an electrode terminal of the corresponding battery cell.

8. The battery device having anti-fire spreading structure according to claim 7, wherein a height difference is existed between a plane of the conductive metal surface and a plane of the electrode terminal of each of the battery cells, the electrode terminal of each of the battery cells is connected to the conductive metal surface via the fuse of upward bending.
